(19) United States
(12) Patent Application Publication
(10) Pub. No.: US 2026/0218335 A1
(43) Pub. Date: Jul. 30, 2026

(54) METHOD FOR REMOVING THE ACTINIUM CONTAINED IN A RARE EARTH SOLUTION WITH AN ORGANOPHOSPHORUS SOLVENT AND RARE EARTH COMPOSITIONS OBTAINED BY THIS METHOD

(71) Applicant: CARESTER, LYON CEDEX 03 (FR)

(72) Inventors: Clémence Bertuol, Paris (FR); Alain Rollat, Paris (FR); Alain Leveque, Montroy (FR)

(73) Assignee: CARESTER, Lyon (FR)

(21) Appl. No.: 19/142,167

(22) PCT Filed: Oct. 18, 2024
(86) PCT No.: PCT/FR2024/051372

§ 371 Date: Jun. 20, 2025

(30) Foreign Application Priority Data
Oct. 18, 2023 (FR) FR2311246
Feb. 9, 2024 (FR) FR2401271

(51) Int. Cl. C22B 60/00; C22B 3/38; C22B 59/00

(52) U.S. Cl. CPC C22B 60/00; C22B 3/3844; C22B 59/00

(57) ABSTRACT

A method for removing the actinium contained in an initial aqueous solution of rare earth sulfates includes contacting and mixing the initial aqueous solution with an organic solvent. The organic solvent includes at least one cationic extraction agent. The method includes separating by liquid-liquid extraction the rare earths and the actinium, contacting the organic solvent comprising the rare earths, with the exception of a portion of the lanthanum, with an acid solution, to produce a rare earth solution having an actinium concentration lower than the actinium concentration of the initial aqueous solution. The rare earth solution constituting a rare earth composition comprising the rare earths Ce, Pr, Nd, Sm, Eu, Gd, Tb, Dy, Ho, Er, Tm, Yb, Lu, and Y, and the La concentration of which is lower than that of the initial aqueous solution.

### FIELD OF THE INVENTION

The invention falls within the general scope of the treatment of aqueous rare earth solutions. More specifically, it concerns a method for removing a radioactive compound from an aqueous solution, resulting from the treatment of rare earth ores, by liquid-liquid extraction. The invention also concerns a rare earth composition resulting from the liquid/liquid extraction of an initial aqueous solution of rare earth sulfates.

### BACKGROUND

Ores having rare earths extracted therefrom may enclose radioactive compounds, which have to be separated from the rare earths. For example, monazite comprises all the radioactive isotopes of the thorium 232 (²³²Th), uranium 235 (²³⁵U), and uranium 238 (²³⁸UJ) families. Ores generally undergo, to begin with, a first treatment step which consists in a physical concentration (magnetic separation, flotation . . . ). However, during this step, the radioactive isotopes present in the ore are not separated from the rare earths. During a second step, chemical treatments on the previously obtained concentrate are performed. During these chemical treatments, the radioactive balance of the three previously-mentioned radioactive families is disrupted and each radioelement will evolve according to its specific chemical properties, independently of the other elements in the radioactive family.

Certain isotopes disintegrate rapidly, while others, which have a radioactive period longer than a few days, should be removed to avoid contaminating the rare earths. For example, the following isotopes have a relatively long radioactive period:
Family of ²³²Th: ²³²Th, ²²⁸Th, ²²⁸Ra,
Family of ²³⁸UJ: ²³⁸UJ, ²³⁴UJ, ²³⁴Th, ²³⁰Th, ²²⁶Ra, ²¹⁰Pb, ²¹⁰Po,
Family of ²³⁵UJ: ²³⁵UJ, ²³¹ Pa, ²²⁷ Ac, ²²³Ra.

Most of these elements have chemical properties sufficiently different from those of rare earths for their removal to be performed with conventional hydrometallurgical techniques, such as precipitation and filtering. Such is the case, for example, for the isotopes of thorium, uranium, radium (Ra), lead (Pb), polonium (Po), and protactinium (Pa).

However, the case of isotope ²²⁷Ac, which has a radioactive period of 22 years, is singular since its chemical properties are close to those of rare earths, and in particular to those of lanthanum. During rare earth separation, the actinium will follow the lanthanum and it risks accumulating in the compounds which comprise lanthanum. It will then need to be removed in the radioactive waste management stream, which requires additional costs. It is thus necessary to implement methods of separation of rare earths and of actinium, enabling to efficiently remove the ²²⁷Ac isotope.

Such actinium removal methods are described, for example, in document WO 2019/000014 where actinium is precipitated from solutions of rare earths chlorides or nitrates, which result from the treatment of monazite or xenotime type ores, by adding sulfate salts. The disadvantage of this method is that it requires adding significant quantities of salt (in the order of some hundred g/L) to generate the precipitation. Further, this method is relatively time intensive. Moreover, it does not enable to remove a sufficient amount of actinium.

Other methods describe the separation by liquid-liquid extraction of rare earths and of actinium. This extraction is performed by means of organic solvents comprising molecules selective for rare earths, which are extracted in the organic phase while the actinium remains in the aqueous phase. Indeed, it is known to use as extracting agents, cationic agents which have a strong affinity for rare earths, such as derivatives of organophosphorus acids.

As an example, document CN 85100148 describes a method for producing lanthanum oxides, by separation of the lanthanum and of the actinium present in a solution of rare earth nitrates. The liquid-liquid separation is performed by means of an organic solvent comprising the (2-ethylhexyl)phosphonic acid mono-2-ethylhexyl ester (HEHEHP) or the di(2-ethylhexyl)phosphoric acid (HDEHP or D2EHPA).

Similarly, document KR 100351554 details a method of liquid-liquid separation of rare earths and of the actinides contained in solutions of rare earth nitrates, originating from liquid radioactive waste. The method implies the use of tributyl phosphate and of phosphoric acid esters in the form of metal salts.

Another problem linked to the presence of actinium in rare earth solutions concerns transportation. Indeed, ore having a uranium content of 5,000 ppm relative to the sum of the contained rare earths causes an ²²⁷ Ac content which generates an activity equivalent to approximately 2.4 Bq/g of rare earths. Now, beyond 1 Bq/g, the transportation of such a mixture is subject to strict regulations concerning the transportation of so-called “class-7” radioactive material. This requires resorting to dedicated carriers, which implies an additional constraint and cost. It is thus necessary to limit steps of transportation of such products, particularly by directly processing the solutions originating from the ore, without intermediate steps.

Further, during rare earth production operations, intermediate manufacturing concentrates are submitted to strict radioprotection regulations. In particular, concentrates having an activity related to the presence of ²²⁷ Ac exceeding 0.1 Bq/g require a particular tracking of workers.

### DISCUSSION OF THE INVENTION

One of the aims of the invention is to remove actinium from as soon as the production of a rare earth solution resulting from ore treatment, to avoid the production, the transportation, and subsequent and costly treatments of radioactive intermediate rare earth concentrates. This removal of actinium goes along with the removal of part of the lanthanum. This rare earth having little commercial value, this enables to considerably decrease the total mass of the intermediate rare earth concentrate to be transported and very significantly decreases the cost of separation methods implemented by the users of said concentrate.

Thus, the invention concerns a method for removing actinium, as well as part of the lanthanum, contained in an initial aqueous solution of rare earth sulfates, said aqueous solution resulting from the ore treatment. The method comprises the following steps:
contacting and mixing the initial aqueous solution with an organic solvent non-miscible in water, said organic solvent comprising at least one cationic extraction agent,
separating by liquid-liquid extraction the rare earths and of the actinium, the rare earths, with the exception of part of the lanthanum and possibly of the cerium, being extracted into the organic solvent,
contacting the organic solvent comprising the rare earths, with the exception of part of the lanthanum, with an acid solution, to produce a rare earth solution having an actinium concentration smaller than the actinium concentration of the initial aqueous solution of rare earth sulfates, said rare earth solution constituting a rare earth composition comprising the rare earths Ce, Pr, Nd, Sm, Eu, Gd, Tb, Dy, Ho, Er, Tm, Yb, Lu, and Y, and having an La concentration lower than that of the initial aqueous solution.

The invention also concerns a rare earth composition resulting from the method according to the invention.

The rare earth composition has an ²²⁷Ac content lower than 0.10 Bq/g of rare earths, preferably lower than 0.01 Bq/g of rare earths,
the alkaline-earth and lead content of said rare earth composition being lower than 1,000 ppm relative to the quantity of rare earths, preferably lower than 100 ppm relative to the quantity of rare earths, and said rare earth composition being in solid form or in the form of an aqueous solution.

### Organic Solvent

According to the invention, the organic solvent comprises at least one cationic extraction agent which is an organophosphorus acid.

Preferably, the cationic extraction agent is an organophosphorus acid selected from the group comprising:
monoacid diesters of phosphoric acid, of formula I:

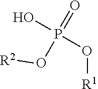

monoacid diesters of phosphonic acids, of formula II:

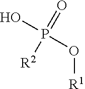

phosphinic acids, of formula III:

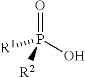

and their mixtures,
where R₁ and R₂ are identical or different, selected independently from the group comprising alkyl or aryl radicals, linear or branched, aliphatic or aromatic, from 1 to 20 carbon atoms, preferably from 4 to 20 carbon atoms.

These compounds are particularly effective to complex trivalent cations, such as rare earth cations. According to the invention, the rare earths are selected from the group comprising: scandium, yttrium, lanthanum, cerium, praseodymium, neodymium, samarium, europium, gadolinium, terbium, dysprosium, holmium, erbium, thulium, ytterbium, lutecium, and their mixtures.

Advantageously, the cationic extraction agent may be selected from the group formed of the di(2-ethylhexyl)phosphoric acid ester, 2-ethylhexyl phosphonic acid mono-2-ethylhexyl ester, bis(2,4,4-trimethylpentyl)phosphinic acid (known under trade name CYANEX®272), CYANEX®572 (mixture of phosphonic acid and of phosphinic acid), and their mixtures.

Additionally, the organic solvent may comprise a diluent compound, selected from the group formed by hydrocarbons with from 5 to 16 carbon atoms, linear or branched, aliphatic or aromatic.

For example, the diluent compound is selected from the group comprising: decane and its isomers, dodecane and its isomers, kerosene, toluene, aliphatic hydrocarbons having between 10 and 14 carbon atoms, hydrocarbons with 10 carbon atoms comprising at least one aromatic function, and their mixtures.

As a diluent compound, Shellsol®D70 (aliphatic hydrocarbon), Solvesso®150 (aromatic hydrocarbon) may for example be mentioned.

The diluent compound enables to dissolve the cationic extraction agent, and optionally the modifier compound. II is different from the cationic extraction agent.

In addition to the cationic extraction agent and the diluent compound, the solvent may comprise at least one modifier compound, selected from the group comprising neutral phosphoric acid esters, neutral phosphonic acid esters, fatty alcohols, linear or branched, sulfoxides, carboxylic acids with linear or branched alkyl chains, having a total number of carbon atoms in the range from 6 to 16.

Preferably, the modifier compound is selected from the group comprising: tributyl phosphate, decan-1-ol, octan-1-ol, isodecan-1-ol, hexan-1-ol, dodecan-1-ol, 2-ethylhexanol, dibutyl sulfoxide, dihexyl sulfoxide, mixtures of sulfoxides derived from petroleum, 2-ethylhexanoic acid, neodecanoic acid, and their mixtures.

In the sense of the invention, there is designated by “modifier compound” a chemical species other than the cationic extraction agent and the diluent compound, likely to change certain properties of the organic solvent. For example, the modifier compound may delay the occurrence of a third phase, help decantation or change the extraction efficiencies.

According to a specific embodiment, the organic solvent comprises at least one cationic extraction agent and at least one diluent compound.

As a variant, the organic solvent may comprise at least one cationic extraction agent, at least one diluent compound, and at least one modifier compound.

Preferably, the organic solvent has a cationic extraction agent concentration in the range from 0.1 to 2 mol/L, preferably from 0.3 to 1.5 mol/L. Such a concentration enables the solvent to keep a viscosity lower than 20 cP at room temperature, that is, between 20° C. and 27° C., preferably at 25° C.

In a specific embodiment of the invention, the organic solvent comprises:
from 15% to 100% of at least one cationic extraction agent,
from 0% to 85% of at least one diluent compound,
   by weight, relative to the total weight of the organic solvent, the total being equal to 100%.

In another embodiment of the invention, the organic solvent comprises:
from 15% to 70% of at least one cationic extraction agent,
from 0% to 85% of at least one diluent compound,
from 0% to 50% of at least one modifier compound,
   by weight, with respect to the total weight of the organic solvent, the total being equal to 100%.

### Initial Aqueous Solution of Rare Earth Sulfates

The rare earth concentration in the initial aqueous solution of rare earth sulfates may be in the range from 100 mg/L to 40 g/L, that is, from 0.001 to 0.3 mol/L.

Preferably, the initial aqueous solution of rare earth sulfates results from the chemical treatment of a concentrate of xenotime and/or monazite type ore, in particular with sulfuric acid. This concentrate may be obtained by physical ore concentration. Physical concentration methods include as an example magnetic separation and flotation, without for the present invention to be limited to these methods.

Alternatively, the initial aqueous solution of rare earth sulfates may result from the treatment of ionic clays with ammonium sulfate, alkaline sulfates, or magnesium sulfate.

According to the nature of the ore from which the solution originates, the activity of the initial aqueous solution related to the ²²⁷ Ac content is in the range from 0.1 to 25 Bq/g of rare earths.

### Liquid-Liquid Extraction

In practice, the contacting and the mixing of the initial aqueous solution of rare earth sulfates with the organic solvent may be carried out in a device comprising a plurality of stages, for example a battery of mixers-settlers or an extraction column. In this device, the initial aqueous solution and the organic solvent advantageously flow countercurrent to each other.

Advantageously, the method is carried out at a temperature in the range from 20° C. to 60° C., preferably from 30° C. to 50° C.

Preferably, the device comprises an extraction section and a stripping section. It may further comprise a washing section. Each section may be formed of from 1 to 10 stages.

According to an embodiment, the solvent may be saponified by a basic solution (ammonia, magnesia, etc.) with an OH ion concentration in the range from 0.5 to 10 mol/L.

Once the rare earths have been extracted into the organic solvent, the latter is placed into contact with an acid solution which is selected from the group comprising nitric acid, sulfuric acid, or hydrochloric acid solutions.

This contacting or washing of the organic solvent may be carried out in the washing section.

In practice, a rare earth composition is obtained at the end of the liquid-liquid extraction comprising all or part of the rare earths initially present in the initial aqueous solution but having a decreased La content.

This composition, which is a solution of rare earth nitrates, sulfates, or chlorides, advantageously has an activity, related to the actinium content, lower than 0.1 Bq/g of rare earths, preferably lower than 0.01 Bq/g of rare earths.

The method according to the invention thus has the advantage of decreasing the relative content of La with respect to the other rare earths contained in the rare earth composition, as compared with the initial aqueous solution of rare earth sulfates.

Preferably, the mass percentage of lanthanum relative to the total mass percentage of rare earths is lower than that of the initial aqueous solution of rare earth sulfates.

Preferably, the rare earth composition comprises no lanthanum.

The decrease in the La content is important from an economical point of view since, on the one hand, it enables to decrease transportation costs, if relevant, and on the other hand, it decreases the cost of the separations carried out downstream, resulting in the separate rare earths, in particular at the costs of production of pure praseodymium, neodymium, terbium, and dysprosium.

Generally, an aqueous raffinate having a content of lanthanum with respect to the other rare earths greater than 90% is obtained.

According to an embodiment, the rare earth composition is precipitated by means of a precipitant selected from the group comprising: sodium carbonate, ammonium bicarbonate, sodium hydroxide, ammonia, and oxalic acid or its alkaline salts.

The precipitation of the composition causes the forming of rare earth carbonates, oxycarbonates, hydroxycarbonates, hydroxides, hydroxynitrates, or oxalates. Advantageously, the precipitates are calcinated to obtain oxides.

According to another embodiment, the rare earth composition is crystallized or cast at high temperature, preferably between 110° C. and 150° C., preferably at the atmospheric pressure.

For example, the crystallization of rare earth nitrate or chloride solutions generates crystallized nitrates or crystallized chlorides, while the high-temperature casting of these solutions followed by their cooling causes the forming of anhydrous nitrates or of anhydrous chlorides.

### Rare Earth Composition

In practice, the rare earth composition has a total activity lower than 0.10 Bq/g of rare earths, preferably lower than 0.01 Bq/g of rare earths. The total activity is linked to the content of radioelements, for example, ²²⁶Ra, ²²⁸Ra, ²³²Th, ²³⁸U, or ²³¹ Pa, and their descendants in the composition.

This composition advantageously has an ²²⁷Ac content lower than 0.10 Bq/g of rare earths.

This rare earth composition may contain all or part of the rare earths and advantageously has a relative La content with respect to the other rare earths decreased with respect to the La content in the initial aqueous solution.

The rare earth composition is in solid form or in the form of an aqueous solution.

When the composition is in solid form, it is present in the form of a solid selected from the group comprising: rare earth carbonates, hydroxycarbonates, oxycarbonates, hydroxides, oxides, oxalates, hydroxynitrates, crystallized nitrates, anhydrous nitrates, crystallized chlorides, and anhydrous chlorides.

When the composition is in the form of an aqueous solution, the rare earth composition is an aqueous solution selected from the group of aqueous solutions of rare earth nitrates, sulfates, or chlorides.

Advantageously, the rare earth concentration in the aqueous solution is in the range from 1 g/L to 500 g/L. Preferably, the rare earth concentration is in the range from 50 to 450 g/L in a solution of nitrates, between 5 and 30 g/L in an aqueous solution of sulfates and from 50 to 200 g/L in an aqueous solution of chlorides.

### DETAILED DESCRIPTION OF THE DRAWINGS

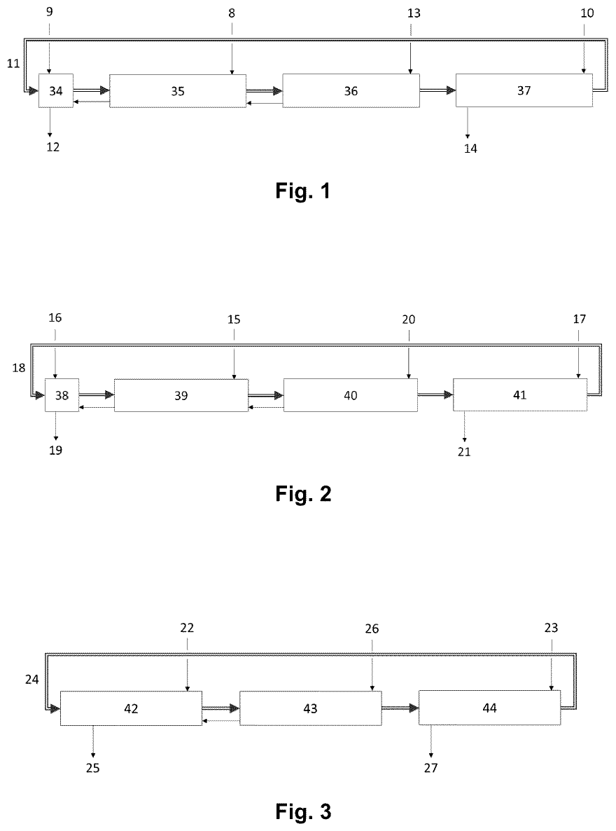

FIG. 1 is a simplified representation of the method according to example 1 of the invention, in a liquid-liquid extraction battery formed of three sections.

FIG. 2 is a simplified representation of the method according to example 2 of the invention, in a liquid-liquid extraction battery formed of two sections.

FIG. 3 is a simplified representation of the method according to example 3 of the invention, in a liquid-liquid extraction battery formed of three sections.

### EXAMPLES OF EMBODIMENT OF THE INVENTION

The above examples have been simulated by means of software, called “PAREX+”, implemented by the Applicant, where the basic data necessary to the calculations have been previously obtained by laboratory tests according to the different disclosed chemical systems.

Two types of aqueous solutions resulting from the chemical treatment of rare earth ores are considered:
an aqueous solution of rare earth sulfates resulting from the treatment of raw material of ionic clay type;
an aqueous solution of rare earth sulfates resulting from the treatment of raw material of xenotime type.

The following examples have been calculated for an installation such as a battery of mixers-settlers with a continuous, countercurrent operation, and having the following performance:
the extraction efficiency of all rare earths having a greater atomic number than cerium (Pr, Nd, Sm, Eu, Gd, Tb, Dy, Ho, Er, Tm, Yb, and Lu) as well as that of yttrium is greater than 99%,
the purification rate of ²²⁷Ac relative to rare earths, which is equal to the ratio of the ²²⁷ Ac content per gram of rare earths in the aqueous feed and the ²²⁷Ac content per gram of rare earths in the extracted aqueous solution is greater than 100.

### Example 1: Removal of ²²⁷ Ac from a Solution of Rare Earth Sulfates Obtained by Chemical Treatment of Ionic Clays by a (NH₄)₂SO₄ Solution

The method according to the invention is carried out by means of the following device: a liquid-liquid extraction battery of mixer-settler type operating in countercurrent, formed of a one-stage loading section (34), of a two-stage extraction section (35), of a two-stage washing section (36), and of a seven-stage stripping section (37), these four sections being coupled together.

The extraction section (35) is fed with an aqueous solution (8) comprising a mixture of rare earth sulfates (La, Ce, Pr, Nd, Sm, Eu, Gd, Tb, Dy, Ho, Er, Tm, Yb, Lu, and Y) and of ²²⁷Ac, with a 120 800 L/h flow rate, having a composition detailed in table 1.

Solvent S1 (11), formed by 67 vol. % of aliphatic kerosene and 33 vol. % of HEHEHP (where HEHEHP is the cationic extraction agent), is injected at a 10,000-L/h flow rate into the loading section (34). Solvent S1 is saponified by a solution of ammonia (9) with an OH concentration of 4 mol/L, at a 1,000-L/h flow rate.

An aqueous raffinate (12) very predominantly comprising La as well as almost all the ²²⁷ Ac is obtained with a 126,323-L/h flow rate. The measured activity is 27 Bq/g of rare earths.

Solvent S1 is washed with a solution of sulfuric acid (13) at a 0.7-mol/L concentration, with a 4,248-L/h flow rate in the washing section (36).

An aqueous solution of nitric acid (10) with a 3.5-mol/L concentration is fed into the stripping section (37) with a 2,523-L/h flow rate, thus enabling to regenerate the solvent.

An aqueous extract (14) of rare earths, the La content of which has been substantially decreased with respect to those of the feed solution, is obtained with a 2,636-L/h flow rate. This extract has a rare earth concentration of 31 g/L and an activity, related to the ²²⁷Ac content, of 1.3.103 Bq/g of rare earths

The purification rate for ²²⁷ Ac with respect to rare earths, which is equal to the ratio of the ²²⁷ Ac content per gram of rare earths in the aqueous feed (8) to the ²²⁷Ac content per gram of rare earths in the extracted aqueous solution (14) is in these conditions close to 5,000.

The summary outline of the method of the example 1 according to the invention is shown in FIG. 1.

The rare earth quantities and the flow rates are indicated in table 1.

TABLE 1

| Step | Feed. | Load. | Strip. | S1 | Raff. | Wash. | Ext. |
|---|---|---|---|---|---|---|---|
| Flow | 8 | 9 | 10 | 11 | 12 | 13 | 14 |
| Nature | Aqueous | Aqueous | Aqueous | Organic | Aqueous | Aqueous | Aqueous |
| Flow rate (L/h) | 120,800 | 1,000 | 2,523 | 10,000 | 126,323 | 4,248 | 2,636 |
| RE flow rate (kg_{RE}/h) | 106 | | | | 25 | | 81 |
| La (g/L) | 0.32 | | | | 0.20 | | 5.2 |
| Ce (g/L) | 0.04 | | | | 0.0002 | | 1.9 |
| Pr (g/L) | 0.05 | | | | <0.0001 | | 2.4 |
| Nd (g/L) | 0.16 | | | | <0.0001 | | 7.2 |
| Sm (g/L) | 0.02 | | | | <0.0001 | | 1.1 |
| Eu (g/L) | <0.10 | | | | <0.0001 | | 0.08 |
| Gd (g/L) | 0.02 | | | | <0.0001 | | 1.1 |
| Tb (g/L) | <0.01 | | | | <0.0001 | | 0.21 |
| Dy (g/L) | 0.02 | | | | <0.0001 | | 1.1 |
| Ho (g/L) | 0.01 | | | | <0.0001 | | 0.25 |
| Er (g/L) | 0.01 | | | | <0.0001 | | 0.68 |
| Tm (g/L) | <0.001 | | | | <0.0001 | | 0.08 |
| Yb (g/L) | 0.01 | | | | <0.0001 | | 0.55 |
| Lu (g/L) | <0.001 | | | | <0.0001 | | 0.08 |
| Y (g/L) | 0.19 | | | | <0.0001 | | 8.8 |
| ²²⁷Ac (Bq/g_{RE}) | 6.35 | | | | 27 | | 1.2910⁻³ |
| OH⁻ (mol/L) | | 4 | | | | | |
| H₂SO₄ (mol/L) | 0.001 | | | | 0.00598 | 0.66 | |
| HNO₃ (mol/L) | | | 3.5 | | | | 2.32 |
| HEHEHP (% vol) | | | | 33 | | | |
| Kerosene (% vol) | | | | 67 | | | |

The abbreviations correspond to the following steps:
Feed.: feeding of the aqueous rare earth solution (8) into the extraction section (35)
Load.: loading of the ammonia solution (9) into the loading section (34)
Strip.: stripping of the rare earths by addition of an aqueous solution of nitric acid (10) into the stripping section (37)
Raff.: aqueous raffinate (12) from the loading section (34)
Wash.: washing, regeneration of the solvent by means of a sulfuric acid solution (13) in the washing section (36)
Ext.: aqueous extract (14) from the stripping section (37)
RE: rare earths
Nature: nature of the flow
g_{RE}: gram of rare earths
kg_{RE}: kilogram of rare earths

The extract solution (14) has an ²²⁷ Ac activity equal to 1.3×10⁻³ Bq/g of rare earths, that is, 4×10⁻² Bq/liter of solution.

This solution is precipitated in the form of carbonate by addition of ammonium bicarbonate.

After filtering, a wet rare earth carbonate containing 30% of humidity and 40.4% of rare earths is obtained.

This solid has an ²²⁷ Ac activity equal to 1.3×10⁻³ Bq/g of rare earths, that is, 5.2×10⁻⁴ Bq/g of solid.

This solid is then calcinated at 900° C. An oxide containing 83.2% of rare earths is then obtained. This solid has an ²²⁷ Ac activity equal to 1.3×10⁻³ Bq/g of rare earths, that is, 1.1×10⁻³ Bq/g of solid.

### Example 2: Removal of ²²⁷Ac from a Solution of Rare Earth Sulfates Obtained by Treatment at 500° C. Of a Xenotime Concentrate by a Sulfuric Acid Solution

The method according to the invention is carried out by means of the following device: a liquid-liquid extraction battery of mixer-settler type with a continuous, countercurrent operation, formed of a one-stage loading section (38), of a two-stage extraction section (39), of a one-stage washing section (40), and of a seven-stage stripping section (41), these four sections being coupled together.

The extraction section (39) is fed with an aqueous solution (15) comprising a mixture of rare earth sulfates (La, Ce, Pr, Nd, Sm, Eu, Gd, Tb, Dy, Ho, Er, Tm, Yb, Lu, and Y) and of ²²⁷ Ac, with a 7,927-L/h flow rate, having its composition detailed in table 2.

Solvent S1 (18), formed of 67 vol. % of aliphatic kerosene and 33 vol. % of HEHEHP (cationic extraction agent) is injected at a 6,650-L/h flow rate into the loading section (38). Solvent S1 is saponified by an ammonia solution (16) with an OH concentration of 4 mol/L at a 665-L/h flow rate.

An aqueous raffinate (19) very predominantly comprising La as well as almost all the ²²⁷ Ac is obtained with a 8,966-L/h flow rate. The measured activity is 167 Bq/g of rare earths.

Solvent S1 is washed with a solution of sulfuric acid (20) at a 0.4-mol/L concentration with a 84-L/h flow rate in the washing section (40).

An aqueous solution of nitric acid (17) at a 3.5-mol/L concentration is fed into the stripping section (41) with a 2,671-L/h flow rate

An aqueous rare earth extract (21), having a content substantially decreased with respect to that of the feed solution, is obtained with a 2,798-L/h flow rate. It has a 37-g/L rare earth concentration and an activity, related to the ²²⁷ Ac content, of 2.27.104 Bq/g of rare earths.

The purification rate for ²²⁷Ac, which is equal to the ratio of the ²²⁷Ac content per gram of rare earths in the aqueous feed (15) to the ²²⁷Ac content per gram of rare earths in the extracted aqueous solution (21), is close to 5,200.

The summary outline of the method of the example 2 according to the invention is shown in FIG. 2.

The rare earth quantities and the flow rates are indicated in table 2.

TABLE 2

| | Feed. | Load. | Strip. | Solvent S1 | Raff. | Washing | Ext. |
|---|---|---|---|---|---|---|---|
| Flow | 15 | 16 | 17 | 18 | 19 | 20 | 21 |
| Nature | Aqueous | Aqueous | Aqueous | Organic | Aqueous | Aqueous | Aqueous |
| Flow rate (L/h) | 7,927 | 665 | 2,671 | 6,650 | 8,966 | 84 | 2,798 |
| RE flow rate (kg_{RE}/h) | 104 | | | | 1 | | 103 |
| La (g/L) | 0.29 | | | | 0.080 | | 0.57 |
| Ce (g/L) | 0.69 | | | | 0.003 | | 1.95 |
| Pr (g/L) | 0.10 | | | | <0.0001 | | 0.28 |
| Nd (g/L) | 0.46 | | | | <0.0001 | | 1.31 |
| Sm (g/L) | 0.30 | | | | <0.0001 | | 0.85 |
| Eu (g/L) | 0.07 | | | | <0.0001 | | 0.18 |
| Gd (g/L) | 0.82 | | | | <0.0001 | | 2.31 |
| Tb (g/L) | 0.18 | | | | <0.0001 | | 0.50 |
| Dy (g/L) | 1.20 | | | | <0.0001 | | 3.41 |
| Ho (g/L) | 0.26 | | | | <0.0001 | | 0.73 |
| Er (g/L) | 0.75 | | | | <0.0001 | | 2.11 |
| Tm (g/L) | 0.10 | | | | <0.0001 | | 0.29 |
| Yb (g/L) | 0.61 | | | | <0.0001 | | 1.73 |
| Lu (g/L) | 0.08 | | | | <0.0001 | | 0.24 |
| Y (g/L) | 7.20 | | | | <0.0001 | | 20.39 |
| ²²⁷Ac (Bq/g_{RE}) | 1.18 | | | | 167 | | 2.27.10⁻⁴ |
| OH⁻ (mol/L) | | 4 | | | | | |
| H₂SO₄(mol/L) | 0.001 | | | | 0.02 | 0.4 | |
| HNO₃ (mol/L) | | | 3.5 | | | | 2.34 |
| HEHEHP (% vol) | | | | 33 | | | |
| Kerosene (% vol) | | | | 67 | | | |

The abbreviations correspond to the following steps:
Feed.: feeding of the aqueous rare earth solution (15) into the extraction section (39)
Load.: loading of the ammonia quantities (16) into the loading section (38)
Strip.: stripping of the rare earths by addition of an aqueous solution of nitric acid (16) into the stripping section (41)
Raff.: aqueous raffinate (19) from the loading section (38)
Ext.: aqueous extract (21) from the stripping section (41)
RE: rare earths
Nature: nature of the flow
g_{RE}: gram of rare earths
kg_{RE}: kilogram of rare earths

The extract solution (21) has an ²²⁷Ac activity equal to 2.3×10⁻⁴ Bq/g of rare earths, that is, 8.4×10⁻³ Bq/liter of solution.

This solution is precipitated in the form of oxalate by addition of oxalic acid.

After filtering, a wet rare earth oxalate containing 30% of humidity and 31.8% of rare earths is obtained. This solid has an ²²⁷Ac activity equal to 2.3×10⁻⁴ Bq/g of rare earths, that is, 7.2×10⁻⁵ Bq/g of solid.

This solid is then calcinated at 900° C. An oxide containing 83.2% of rare earths is then obtained. This solid has an ²²⁷ Ac activity equal to 2.3×10⁻⁴Bq/g of rare earths, that is, 1.8×10⁻⁴ Bq/g of solid.

### Example 3: Removal of ²²⁷Ac from a Solution of Rare Earth Sulfates Obtained by Treatment at 500° C. Of a Xenotime Concentrate by a Sulfuric Acid Solution

The method according to the invention is carried out by means of the following device: a liquid-liquid extraction battery of mixer-settler type with a continuous, countercurrent operation, formed of a four-stage extraction section (42), of a four-stage washing section (43), and of a seven-stage stripping section (44), these three sections being coupled together.

The extraction section (42) is fed with an aqueous solution (22) comprising a mixture of rare earth sulfates (La, Ce, Pr, Nd, Sm, Eu, Gd, Tb, Dy, Ho, Er, Tm, Yb, Lu, and Y) and of ²²⁷ Ac, with a 7,927-L/h flow rate, having its composition detailed in table 3.

A solvent S2 (24), formed of 70 vol. % of aliphatic kerosene and 30 vol. % of HDEHP (where HDEHP is the cationic extraction agent) is injected at a 56,000-L/h flow rate.

An aqueous raffinate (25) very predominantly comprising La as well as almost all the ²²⁷ Ac, is obtained with a 8,298-L/h flow rate. The measured activity is 105 Bq/g of rare earths.

Solvent S2 is washed with a solution of sulfuric acid (26) at a 3.1-mol/L concentration with a 162-L/h flow rate in the washing section (43).

An aqueous solution of nitric acid (23) at a 5-mol/L concentration is fed into the stripping section (44) with a 36,000-L/h flow rate.

An aqueous rare earth extract (27), having its La content substantially decreased with respect to that of the feed solution is obtained with a 38,775-L/h flow rate. This extract has a 2.7-g/L rare earth concentration and an activity, related to the ²²⁷Ac content, of 7.8.103 Bq/g of rare earths.

The ²²⁷ Ac purification rate, which is equal to the ratio of the ²²⁷Ac content per gram of rare earths in the aqueous feed (22) to the ²²⁷Ac content per gram of rare earths in the extracted aqueous solution (27), is close to 150.

The summary outline of the method of the example 3 according to the invention is shown in FIG. 3.

The quantities of rare earths and the flow rates indicated in table 3.

TABLE 3

| Step | Feed. | Strip. | S2 | Raff. | Wash. | Ext. |
|---|---|---|---|---|---|---|
| Flow | 22 | 23 | 24 | 25 | 26 | 27 |
| Nature | Aqueous | Aqueous | Organic | Aqueous | Aqueous | Aqueous |
| Flow rate (L/h) | 7,927 | 36,000 | 56,000 | 8,298 | 162 | 38,775 |
| RE flow rate (kg_{RE}/h) | 104 | | | 1 | | 103 |
| La (g/L) | 0.29 | | | 0.130 | | 0.03 |
| Ce (g/L) | 0.69 | | | 0.009 | | 0.14 |
| Pr (g/L) | 0.10 | | | <0.0001 | | 0.02 |
| Nd (g/L) | 0.46 | | | <0.0001 | | 0.09 |
| Sm (g/L) | 0.30 | | | <0.0001 | | 0.06 |
| Eu (g/L) | 0.07 | | | <0.0001 | | 0.01 |
| Gd (g/L) | 0.82 | | | <0.0001 | | 0.17 |
| Tb (g/L) | 0.18 | | | <0.0001 | | 0.04 |
| Dy (g/L) | 1.20 | | | <0.0001 | | 0.25 |
| Ho (g/L) | 0.26 | | | <0.0001 | | 0.05 |
| Er (g/L) | 0.75 | | | <0.0001 | | 0.15 |
| Tm (g/L) | 0.10 | | | <0.0001 | | 0.02 |
| Yb (g/L) | 0.6 | | | <0.0001 | | 0.12 |
| Lu (g/L) | 0.08 | | | <0.0001 | | 0.02 |
| Y (g/L) | 7.20 | | | <0.0001 | | 1.47 |
| ²²⁷Ac (Bq/g_{RE}) | 1.18 | | | 105 | | 7.83.10⁻³ |
| H₂SO₄ (mol/L) | 0.001 | | | 0.40 | 3.1 | |
| HNO₃ (N) | | 5 | | | | 4.6 |
| HDEHP (% vol) | | | 30 | | | |
| Kerosene (% vol) | | | 70 | | | |

The abbreviations correspond to the following steps:
Feed.: feeding of the aqueous rare earth solution (22) into the extraction section (42)
Strip.: stripping of the rare earths by addition of an aqueous solution of nitric acid (23) into the stripping section (44)
Raff.: aqueous raffinate (25) originating from the extraction section (42)
Wash.: washing, regeneration of the solvent (24) by means of a solution of sulfuric acid (26) in the washing section (43)
Ext.: aqueous extract (27) from the stripping section (44)
RE: rare earths
Nature: nature of the flow
g_{RE}: gram of rare earths

The extract solution (27) has an ²²⁷Ac activity equal to 7.8×10⁻³ Bq/g of rare earths, that is, 2.1×10⁻² Bq/liter of solution.

This solution is precipitated in the form of hydroxynitrate by addition of ammonia.

After filtering, a wet rare earth hydroxynitrate containing 40% of humidity and 36% of rare earths is then obtained.

This solid has an ²²⁷ Ac activity equal to 7.8×10⁻³ Bq/g of rare earths, that is, 2.8×10⁻³ Bq/g of solid.

This solid is then calcinated at 900° C. An oxide containing 81.8% of rare earths is then obtained. This solid has an ²²⁷ Ac activity equal to 7.8×10⁻³ Bq/g of rare earths, that is, 6.4×10⁻³ Bq/g of solid.

In addition to the previously-listed disadvantages of the state of the art, there appears that certain prior art methods, such as that described in publication “Cleaning rare earth elements from actinium”, Journal of Alloys and Compounds, vol. 225 (1995), pages 320-323, can only be implemented if the initial aqueous rare earth solution is a solution of rare earth nitrates. This is also the case for the method described in document CN 85100148, which is carried out to purify solutions of lanthanum nitrates only.

Further, the example 3 of document WO 2019/000014, which describes a method for purifying actinium by precipitation, applicable rare earth sulfate solutions, has a ²²⁷ Ac precipitation rate for high ²²⁷ Ac contents (70 Bq/L) of approximately 47%, for a 2% rare earth precipitation rate. The ²²⁷Ac purification rate thus is:

(1−2%)/(1−47%)=1.85

Which is clearly insufficient to make the solution conformal to the international standards ruling the transportation of non-radioactive products.

1. A method for removing the actinium contained in an initial aqueous solution of rare earth sulfates, said aqueous solution resulting from ore treatment, said method comprising the following steps:
contacting and mixing the initial aqueous solution with an organic solvent non-miscible in water, said organic solvent comprising at least one cationic extraction agent,
separation by liquid-liquid extraction of the rare earths and of the actinium, the rare earths, with the exception of part of the lanthanum, being extracted into the organic solvent,
contacting the organic solvent comprising the rare earths, with the exception of part of the lanthanum, with an acid solution, to produce a rare earth solution having an actinium concentration lower than the actinium concentration of the initial aqueous solution of rare earth sulfates,
said rare earth solution constituting a rare earth composition comprising the rare earths Ce, Pr, Nd, Sm, Eu, Gd, Tb, Dy, Ho, Er, Tm, Yb, Lu, and Y, and having an La concentration lower than that of the initial aqueous solution.

2. The method for removing actinium according to claim 1, wherein the cationic extraction agent is an organophosphorus acid selected from the group comprising:
monoacid diesters of phosphoric acid, of formula I: 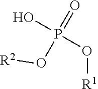
monoacid diesters of phosphonic acid, of formula II: 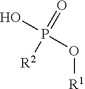
phosphinic acids, of formula III: 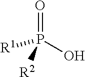
and their mixtures,
where R₁ and R₂ are identical or different, selected independently from the group comprising alkyl or aryl radicals, linear or branched, aliphatic or aromatic, from 1 to 20 carbon atoms.

3. The method for removing actinium according to claim 2, wherein the cationic extraction agent is selected from the group formed of di(2-ethylhexyl)phosphoric acid ester, 2-ethylhexyl phosphonic acid mono-2-ethylhexyl ester, bis(2,4,4-trimethylpentyl)phosphinic acid, and their mixtures.

4. The method for removing actinium according to claim 1, wherein the organic solvent further comprises a diluent compound, selected from the group comprising hydrocarbons of from 5 to 16 carbon atoms, linear or branched, aliphatic or aromatic.

5. The method for removing actinium according to claim 1, wherein the organic solvent has a cationic extraction agent concentration in the range from 0.1 to 2 mol/L.

6. The method for removing actinium according to claim 1, wherein the initial aqueous solution of rare earth sulfates results from chemical treatments of a xenotime and/or monazite concentrate, particularly with sulfuric acid.

7. The method for removing actinium according to claim 1, wherein the initial aqueous solution of rare earth sulfates results from the treatment of ionic clays with ammonium sulfate, alkaline sulfates, or magnesium sulfate.

8. The method for removing actinium according to claim 1, wherein the rare earth concentration in the initial aqueous solution of rare earth sulfates is in the range from 0.001 to 0.30 mol/L.

9. The method for removing actinium according to claim 1, wherein the contacting of the initial aqueous solution of rare earth sulfates with the organic solvent is performed in a device comprising a plurality of stages, where said aqueous solution and the organic solvent flow countercurrent to each other.

10. The method for removing actinium according to claim 1, wherein the acid solution is selected from the group comprising nitric acid, sulfuric acid, or hydrochloric acid solutions.

11. The method for removing actinium according to claim 1, wherein the rare earth composition is a solution of rare earth nitrates, sulfates, or chlorides having an activity, related to the actinium content, lower than 0.10 Bq/g of rare earths, and the mass percentage of lanthanum relative to the mass percentage total of rare earths is lower than that of the initial aqueous solution of rare earth sulfates.

12. The method for removing actinium according to claim 1, wherein the rare earth composition is precipitated by means of a precipitant selected from the group comprising: sodium carbonate, ammonium bicarbonate, sodium hydroxide, ammonia, and oxalic acid or its alkaline salts.

13. The method for removing actinium according to claim 1, wherein the rare earth composition is crystallized or cast at high temperature.

14. A rare earth composition resulting from the method according to claim 1,
said rare earth composition having an ²²⁷Ac content lower than 0.10 Bq/g of rare earths,
the alkaline-earth and lead content of said rare earth composition being lower than 1,000 ppm relative to the quantity of rare earths, and
said rare earth composition being in solid form or in the form of an aqueous solution.

15. The rare earth composition according to claim 14, wherein the total activity is lower than 0.10 Bq/g of rare earths.

16. The rare earth composition according to claim 14, wherein the rare earths belong to the group comprising La, Ce, Pr, Nd, Sm, Eu, Gd, Tb, Dy, Ho, Er, Tm, Yb, Lu, and Y.

17. The rare earth composition according to claim 14, wherein the rare earth composition is an aqueous solution selected from the group comprising aqueous solutions of rare earth nitrates, sulfates, or chlorides.

18. The rare earth composition according to claim 17, wherein the rare earth concentration in the aqueous solution is in the range from 1 g/L to 500 g/L.

19. The rare earth composition according to claim 14, wherein the rare earth composition is in solid form selected from the group comprising rare earth carbonates, hydroxycarbonates, oxycarbonates, hydroxides, hydroxynitrates, oxides, oxalates, crystallized nitrates, anhydrous nitrates, crystallized chlorides, and anhydrous chlorides.

20. The rare earth composition according to claim 14, wherein the mass percentage of lanthanum relative to the total mass percentage of the rare earths contained in the composition is lower than that of the initial aqueous solution of rare earth sulfates.
